(19) United States
(12) Patent Application Publication
(10) Pub. No.: US 2009/0161000 A1
(43) Pub. Date: Jun. 25, 2009

(54) Auto-Focusing Module

(76) Inventors: Chen-Yi Huang, Taichung (TW); De-Sheng Tseng, Taichung (TW)

Correspondence Address: Dr. BANGER SHIA, 102 Lindencrest Ct., Sugar Land, TX, 77479-5201, US

(21) Appl. No.: 12/337,938

(22) Filed: Dec. 18, 2008

(30) Foreign Application Priority Data
Dec. 19, 2007 (TW) 096221664

(51) Int. Cl. G03B 13/36

(52) U.S. Cl. 348/345; 348/E05.045

(57) ABSTRACT

An auto-focusing module comprises a lens, an actuator and an external focusing assembly. The lens is a single-focus optical system and assembled in the actuator. The actuator includes an electric focusing element and conductive pins and is hollow in the direction along the optical axis to accommodate the lens therein. The actuator is exteriorly provided with protruding blocks. The external focusing assembly includes a focusing base and a conductive element. The focusing base is provided with inclined surfaces to engage the external protruding blocks of the actuator. The conductive element is electrically connected with the conductive pins of the actuator. By such arrangements, the actuator can drive the lens to move in the direction of the optical axis to realize automatic focusing.

### BACKGROUND OF THE INVENTION

1. Field of the Invention

The present invention relates to a camera, and more particularly to an auto-focusing module, which can effectively reduce the amount of particles produced and maintain image consistency while reducing module assembly cost.

2. Description of the Prior Art

Optical lens systems for taking image have been used more and more widely, especially mobile phone products on the market must have the image taking function, and middle-end and high-end products of them are all equipped with auto-focusing functions.

As for a common conventional technology, in order to ensure the focus of the optical system to be substantially located on the image plane, the exterior of lens barrel and the interior of an actuator are each provided with a threaded structure, and the distance between a lens and a sensor can be adjusted by rotating the lens. Although the above technology can ensure the focus of the optical system to be located on the image plane of the sensor, it still suffers from the following problems:

1. Conventional products all utilize the threaded design on the lens barrel to assemble and secure the actuator and the lens barrel, so it is likely to cause particles during the assembly process because of the friction of threads.

2. Particles are likely to fall into the optical system during the above process, thus affecting the image quality and image consistency.

In order to solve the above issues effectively, from the approach of reducing the assembly cost and improving the image quality, the inventor of the present invention has developed an auto-focusing module having the advantages of both reducing the assembly cost and improving the image quality.

### SUMMARY OF THE INVENTION

The primary objective of the present invention is to provide an auto-focusing module, which can reduce the occurrence of particles during assembly and focusing, and also reduce assembly cost.

In order to achieve the above objective, a lens of the present invention is assembled in an actuator, the actuator is exteriorly provided with protruding blocks, a focusing assembly includes a focusing base provided with inclined surfaces, and the focusing assembly further includes a conductive element, which is electrically connected with the actuator's conductive pins. After the auto-focusing module is assembled with the sensor, an external fixture can be used to rotate the actuator, and the external protruding blocks of the actuator can engage the inclined surfaces of loading housing, so that the actuator can be driven to move back and forth along the optical axis, thus adjusting the assembly distance between the lens and the sensor. When the object distance changes, the actuator can be driven by an external power supply to provide a displacement required for the lens, so as to locate the focus of the optical system on the image plane of the sensor. The focusing module of the present invention is located outside the actuator, so it can prevent the particles generated during the assembly and focusing process from falling onto the sensor, thus improving the image consistency and reducing assembly defects and assembly cost.

### BRIEF DESCRIPTION OF THE DRAWINGS

FIG. 1 is a cross-sectional view illustrating an auto-focusing module in accordance with a first embodiment of the present invention;

FIG. 2 is a cross-sectional view illustrating an auto-focusing module in accordance with a second embodiment of the present invention; and

FIG. 3 is a cross-sectional view illustrating an auto-focusing module in accordance with a third embodiment of the present invention;

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

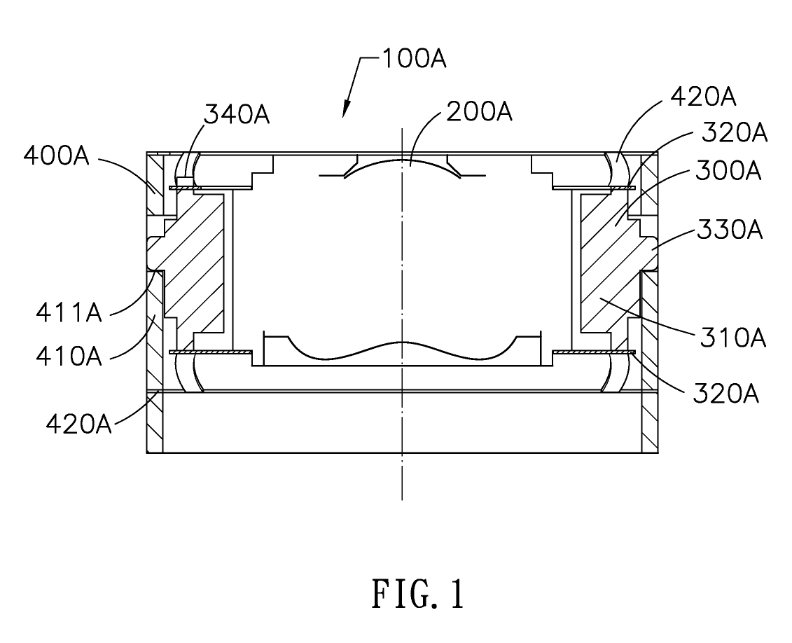

Referring to FIG. 1, an auto-focusing module 100A in accordance with a first embodiment of the present invention essentially comprises a lens 200A, an actuator 300A and an external focusing assembly 400A.

The lens 200A is a single-focus optical system assembled in the actuator 300A and consists of three to four lens elements.

The actuator 300A includes an electric focusing element 310A and conductive pins 320A. The actuator 300A is hollow in a direction of the optical axis to accommodate the lens 200A therein. The actuator 300A is further exteriorly provided with protruding blocks 330A on a periphery thereof, and protruding focusing blocks 340A on an end surface thereof. The electric focusing element 310A is an electrically driven focusing element assembled with the lens 200A and can drive the lens 200A to move a distance of 0.5 mm along the optical axis.

The external focusing assembly 400A includes a focusing base 410A and a conductive element 420A. The focusing base 410A is hollow in the direction of the optical axis and provided with inclined surfaces 411A on a periphery thereof to engage the external protruding blocks 330A of the actuator 300A. The conductive element 420A is electrically connected with the conductive pins 320A of the actuator 300A.

For a better understanding of the present invention, the operation of the first embodiment of the present invention will be illustrated as follows. In the auto-focusing module 100A of the present invention, the actuator 300A is exteriorly provided with four protruding blocks 330A on the periphery thereof, and four protruding focusing blocks 340A on the end surface thereof, so that the external protruding focusing blocks 340A can be used to drive the actuator 300A to rotate, and the external protruding blocks 330A can engage the inclined surfaces 411A of the focusing base 410A to enable the actuator 300A to move along the optical axis, thus adjusting the assembly distance between the lens and the sensor. If the object-distance changes, the actuator 300A can be driven to move the lens a required distance by an external power supply, so as to locate the focus of the optical system on the image plane of the sensor.

Since the present invention adopts an exterior actuator to adjust focus, the problem of loose particles falling off inside can be solved, thus improving the image consistency and reducing assembly cost.

It is to be noted that, the external protruding blocks of the actuator of the present invention are not the only embodiment, instead, they can also be replaced with inclined grooves and the inclined surfaces of the focusing base are replaced with protruding blocks, so that the external inclined grooves of the actuator can also engage the protruding blocks of the focusing base.

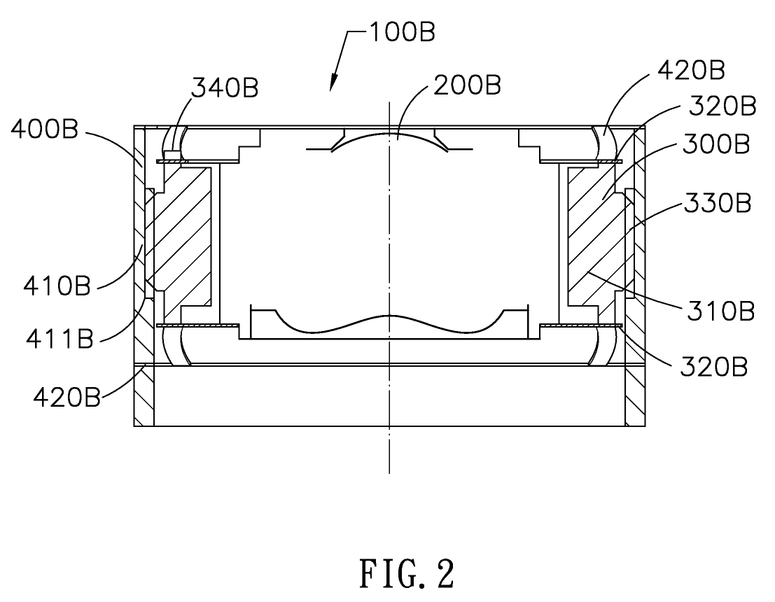

Referring to FIG. 2, an auto-focusing module 100B in accordance with a second embodiment of the present invention essentially comprises a lens 200B, an actuator 300B and an external focusing assembly 400B.

The lens 200B is a single-focus optical system without any threaded structure and assembled in the actuator 300B.

The actuator 300B includes an electric focusing element 310B and conductive pins 320B. The actuator 300B is exteriorly provided with a threaded structure 330B on the periphery thereof, and protruding focusing blocks 340B on an end surface thereof. The electric focusing element 310B is an electrically driven focusing element and assembled with the lens 200B to drive the lens 200B to move a distance of 0.5 mm along the optical axis.

The external focusing assembly 400B includes a focusing base 410B and a conductive element 420B. The focusing base 410B is provided with a threaded structure 411B to engage with the threaded structure 330B of the actuator 300B. The conductive element 420B is electrically connected with the conductive pins 320B.

During the process of focusing, the external protruding focusing blocks 340B can be used to drive the actuator 300B to rotate, and the external threaded structure 330B of the actuator 300B will be screwed with the threaded structure 411B of the focusing base 410B of the external focusing assembly 400B to adjust the distance between the lens and the sensor. Since the threaded structures are located outside the actuator, particles are unlikely to fall into the sensor directly, thus preventing the image quality from being affected by the particles caused during the assembly process. Obviously, the image consistency is improved while the assembly cost is reduced.

The second embodiment of the present invention also has the key technology of the present invention, and the respective cooperative structures are all within the scope of the present invention.

It is to be noted that, the second embodiment of the present invention can further offer the following functions:

1. The external focusing part of the present invention is assembled using a threaded structure, which can effectively increase the focusing adjustment margin.

2. The external focusing part of the present invention is assembled using a threaded structure, which can lower the sensitivity during the process of focusing.

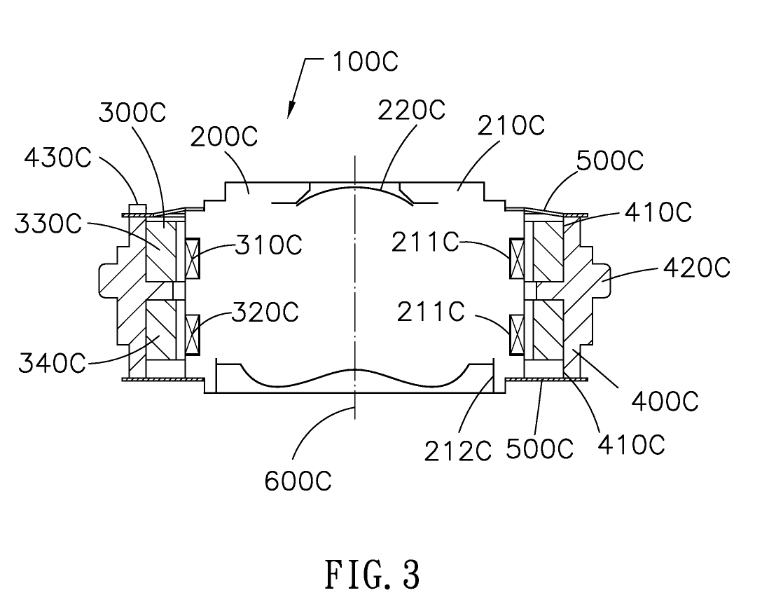

Referring to FIG. 3, an auto-focusing module in accordance with a third embodiment of the present invention provides an actuator 100C comprising a lens 200C, a magnetic circuit system 300C, a loading housing 400C and an elastic element 500C.

The lens 200C includes a lens barrel 210C and an optical lens system 220C. The lens barrel 210C is exteriorly provided with two coil holding tanks 211C and interiorly provided with a lens holding groove 212C. The optical lens system 220C is assembled in the lens holding groove 212C of the lens barrel 210C. The focal length of the lens 200C is smaller than 8 mm.

The magnetic circuit system 300C includes upper loop coils 310C, lower loop coils 320C, upper magnetic elements 330C and lower magnetic elements 340C. The upper loop coils 310C and the lower loop coils 320C are respectively assembled in the holding tanks 211C of the lens barrel 210C in such a manner that the upper loop coils 310C and the lower loop coils 320C are coaxial with the optical axis 600C. The upper magnetic elements 330C and the lower magnetic elements 340C are permanent magnets, and their magnetic pole directions are orthogonal to the optical axis 600C. In addition, the upper magnetic elements 330C and the lower magnetic elements 340C interact with the upper loop coils 310C and the lower loop coils 320C, respectively.

The loading housing 400C is provided with magnetic element holding grooves 410C and provided with four protruding blocks 420C on the outer surface thereof. An end surface of the loading housing 400C vertical to the optical axis, is further provided with four protruding blocks 430C. During the process of external focusing, an external device is used to fix the four protruding blocks 430C on the end surface vertical to the optical axis and rotates the actuator 100C, thus the external protruding blocks 420C of the actuator 100C can engage the inclined surfaces of the focusing base to adjust the distance between the lens and the sensor.

The elastic element 500C is connected with the lens barrel 210C and the loading housing 400C and electrically connected with the coils.

By such arrangements, when the actuator 100C moves, the lens 200C can be driven to move linearly along the optical axis 600C, so as to move the lens a desired distance according to different object distances, and the displacement of the lens can reach 0.5 mm and less.

The third embodiment of the present invention can further offer the following functions:

1. The coils are directly assembled outside the lens barrel, which can effectively reduce the size of the module to meet the market requirement of miniaturization.

2. The focusing method uses the external portion of the actuator to adjust the focus, so it is unlikely to generate particles and contaminate the optical system, thus improving the image quality.

3. The focusing method uses the external portion of the actuator to adjust the focus, so compared to conventional technology the occurrence of an inclination tilt after assembly is reduced, thus reducing assembly defects.

It is to be noted that, the external protruding blocks of the loading housing of the present invention are not the only embodiment, and they can also be replaced with a threaded structure. For the same reason, the protruding blocks on the end surface of the loading housing can also be replaced with grooves. The magnetic circuit can also consist of a single coil interacting with a single magnet. The magnet can also be an integrally-formed ring magnet or consist of multiple pieces of magnetic elements.

To summarize, an auto-focusing module of the present invention comprises a lens barrel, an actuator and an external focusing assembly. The lens is a single-focus optical system and assembled in the actuator. The actuator is exteriorly provided with protruding blocks on the periphery thereof, and the focusing assembly is provided with inclined surfaces on the focusing base. The conductive element of the focusing assembly is electrically connected with the conductive pins of the actuator. After the auto-focusing module is assembled with the sensor, the distance between lens and the sensor can be adjusted by rotating the actuator to enable the lens to move back and forth along the optical axis. The focusing module of the present invention is located outside the actuator, so that the particles generated during the process of assembly and focusing can be prevented from falling into the sensor, thus improving the image consistency and reducing the assembly defects and assembly cost.

While we have shown and described various embodiments in accordance with the present invention, it is clear to those skilled in the art that further embodiments may be made without departing from the scope of the present invention.

What is claimed is:

1. An auto-focusing module at least comprising a lens, an actuator and an external focusing assembly; wherein:
the lens is a single-focus optical system and assembled in the actuator;
the actuator includes an electric focusing element and conductive pins, the actuator is hollow in a direction along an optical axis to accommodate the lens therein and the actuator is exteriorly provided with protruding blocks on a periphery thereof; and
the external focusing assembly includes a focusing base and a conductive element, the focusing base is hollow in the direction along the optical axis and provided with inclined surfaces on an periphery thereof to engage the protruding blocks of the actuator, the conductive element is electrically connected with the conductive pins.

2. The auto-focusing module as claimed in claim 1, wherein the external protruding blocks of the actuator are replaced with inclined grooves, and the inclined surfaces of the focusing base are replaced with protruding blocks to engage the inclined grooves of the actuator.

3. The auto-focusing module as claimed in claim 1, wherein the external protruding blocks of the actuator are replaced with a threaded structure, and the inclined surfaces of the focusing base are replaced with a threaded structure to engage the threaded structure of the actuator.

4. The auto-focusing module as claimed in claim 1, wherein the lens consists of three to four lens elements.

5. The auto-focusing module as claimed in claim 2, wherein the lens consists of three to four lens elements.

6. An actuator at least including a lens, a magnetic circuit system, a loading housing and an elastic element, wherein:
the lens at least includes a lens barrel and an optical lens system, the lens barrel is exteriorly provided with at least one coil holding tank and interiorly provided with a lens holding groove, the optical lens system is assembled in the lens holding groove of the lens barrel;
the magnetic circuit system at least includes a loop coil and a magnetic element, the coil is assembled in the coil holding tank of the lens barrel in such a manner that the loop coil is coaxial with the optical axis, the magnetic element is assembled with the loading housing in such a manner that a magnetic pole direction of the magnetic element is orthogonal to the optical axis, and the magnetic element and the coil interact with each other;
the loading housing is provided with at least one magnetic element holding groove and exteriorly provided with protruding blocks; and
the elastic element is connected with the lens barrel and the loading housing and is electrically connected with the coil.

7. The actuator as claimed in claim 6, wherein the protruding blocks of the loading housing are replaced with a threaded structure.

8. The actuator as claimed in claim 6, wherein the loading housing has an end surface vertical to the optical axis being provided with protruding blocks to be used for external focusing.

9. The actuator as claimed in claim 6, wherein the loading housing has an end surface vertical to the optical axis being provided with grooves to be used for external focusing.

10. The actuator as claimed in claim 6, wherein the lens has a focal length smaller than 8 mm, and a travel of the actuator is no more than 0.5 mm.

11. The actuator as claimed in claim 6, wherein the magnetic element is an integrally-formed ring magnet.
